(19) United States
(12) Patent Application Publication
(10) Pub. No.: US 2026/0161181 A1
(43) Pub. Date: Jun. 11, 2026

(54) MANAGEMENT SYSTEM OF UNMANNED DUMP TRUCK AND MANAGEMENT METHOD OF UNMANNED DUMP TRUCK

(71) Applicant: KOMATSU LTD., Tokyo (JP)

(72) Inventors: Shota KONISHI, Tokyo (JP); Atsushi SAKAI, Tokyo (JP); Akihiro YOSHIMATSU, Tokyo (JP)

(73) Assignee: KOMATSU LTD., Tokyo (JP)

(21) Appl. No.: 19/126,636

(22) PCT Filed: Oct. 20, 2023
(86) PCT No.: PCT/JP2023/037978

§ 371 Date: May 1, 2025

(30) Foreign Application Priority Data
Nov. 14, 2022 (JP) 2022-182114

(51) Int. Cl. G05D 1/667; G05D 1/644; G05D 1/656; G05D 1/69; G05D 105/28

(52) U.S. Cl. CPC G05D 1/667; G05D 1/644; G05D 1/665; G05D 1/69; G05D 2105/28

(57) ABSTRACT

A management system of an unmanned dump truck includes: a path generation unit configured to generate a path indicating a target traveling route of an unmanned dump truck such that the unmanned dump truck enters a discharging point; and an assignment unit configured to assign a second discharging point and a second path to enter the second discharging point to a second unmanned dump truck, based on a first discharging point and a first path to enter the first discharging point assigned to a first unmanned dump truck.

### TECHNICAL FIELD

The present disclosure relates to a management system of an unmanned dump truck and a management method of an unmanned dump truck.

### BACKGROUND ART

In a technical field related to unmanned dump trucks, a management device of a work machine as disclosed in Patent Literature 1 is known.

### PRIOR ART LITERATURE

### Patent Literature

Patent Literature 1: WO2016/167374

### SUMMARY OF INVENTION

### Problem to be Solved by Invention

An unmanned dump truck discharges soil in a discharging area. In a case where a plurality of unmanned dump trucks are present in a discharging area, the unmanned dump trucks need to be stopped in order to avoid mutual interference between the plurality of unmanned dump trucks. If the stop time of the unmanned dump trucks is long, productivity at the work site may decrease.

An object of the present disclosure is to suppress decrease in productivity at the work site.

### Means for Solving the Problem

According to the present disclosure, management system of an unmanned dump truck is provided, the system including: a path generation unit configured to generate a path indicating a target traveling route of an unmanned dump truck such that the unmanned dump truck enters a discharging point; and an assignment unit configured to assign a second discharging point and a second path to enter the second discharging point to a second unmanned dump truck, based on a first discharging point and a first path to enter the first discharging point assigned to a first unmanned dump truck.

### Effects of Invention

According to the present disclosure, a decrease in productivity at the work site is suppressed.

### BRIEF DESCRIPTION OF DRAWINGS

FIG. 1 is a schematic diagram illustrating a work site according to an embodiment.

FIG. 2 is a schematic diagram illustrating a management system of an unmanned dump truck according to the embodiment.

FIG. 3 is a block diagram illustrating the management system for the unmanned dump truck according to the embodiment.

FIG. 4 is a diagram showing the hardware configuration of a management device according to the embodiment.

FIG. 5 is a schematic diagram illustrating the traveling conditions of the unmanned dump truck according to the embodiment.

FIG. 6 is a schematic diagram illustrating a discharging area according to the embodiment.

FIG. 7 is a diagram illustrating an operation of the unmanned dump truck in the discharging area according to the embodiment.

FIG. 8 is a flowchart showing an example of a method of assigning a discharging point and a path according to the embodiment.

FIG. 9 is a diagram illustrating an estimated interference time according to the embodiment.

FIG. 10 is a flowchart illustrating an example of a method of assigning a discharging point and a path in consideration of the arrival time of a subsequent vehicle in the discharging area according to the embodiment.

### DESCRIPTION OF EMBODIMENTS

Hereinafter, an embodiment according to the present disclosure will be described with reference to the drawings, but the present disclosure is not limited to the embodiment. The elements of the embodiment described below can be combined as appropriate. Also, in some cases, some elements are not used.

### [Work Site]

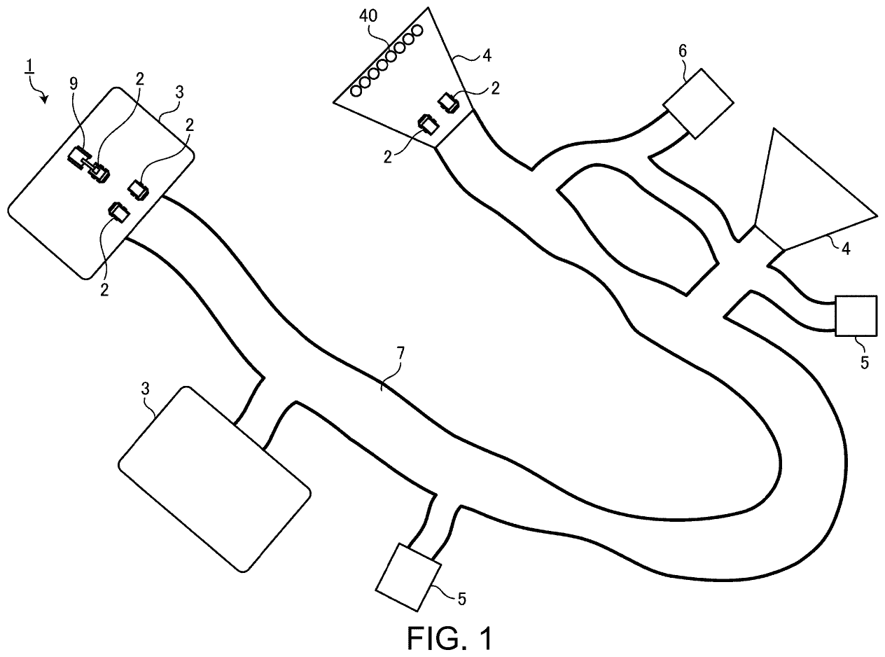

FIG. 1 is a schematic diagram illustrating a work site 1 according to the embodiment. Examples of the work site 1 include a mine or a quarry. The mine refers to a place or a place of business where minerals are mined. The quarry refers to a place or a place of business where stones are mined. Examples of the mine include a metal mine for mining metal, a non-metal mine for mining limestone, or a coal mine for mining coal.

At the work site 1, an unmanned vehicle 2 operates. The unmanned vehicle refers to a vehicle that operates in an unmanned state without depending on a driving operation by a driver. In the embodiment, the unmanned vehicle 2 is a work vehicle traveling in an unmanned state in the work site 1. The unmanned vehicle 2 is a transport vehicle that performs transport work of transporting a load. In the embodiment, the unmanned vehicle 2 is referred to as an unmanned dump truck 2 as appropriate.

The work site 1 is provided with a loading area 3, a discharging area 4, a parking area 5, a fueling area 6, and a traveling track 7. The loading area 3 refers to an area where loading work of loading a load on the unmanned dump truck 2 is performed. Examples of the load include excavated material excavated in the loading area 3. In the loading area 3, a loader 9 operates. Examples of the loader 9 include a hydraulic shovel. The discharging area 4 refers to an area where discharging work of discharging a load from the unmanned dump truck 2 is performed. A plurality of discharging points 40 are set in the discharging area 4. The parking area 5 is an area where the unmanned dump truck 2 is parked. The fueling area 6 refers to an area where the unmanned dump truck 2 is fueled. The traveling track 7 refers to an area where the unmanned dump truck 2 travels. The traveling track 7 is provided so as to connect at least the loading area 3 and the discharging area 4. In the embodiment, the traveling track 7 is connected to each of the loading area 3, the discharging area 4, the parking area 5, and the fueling area 6. The unmanned dump truck 2 can travel in each of the loading area 3, the discharging area 4, the parking area 5, the fueling area 6, and the traveling track 7. The unmanned dump truck 2 travels in the traveling track 7, for example, so as to move to and from the loading area 3 and the discharging area 4.

### [Management System]

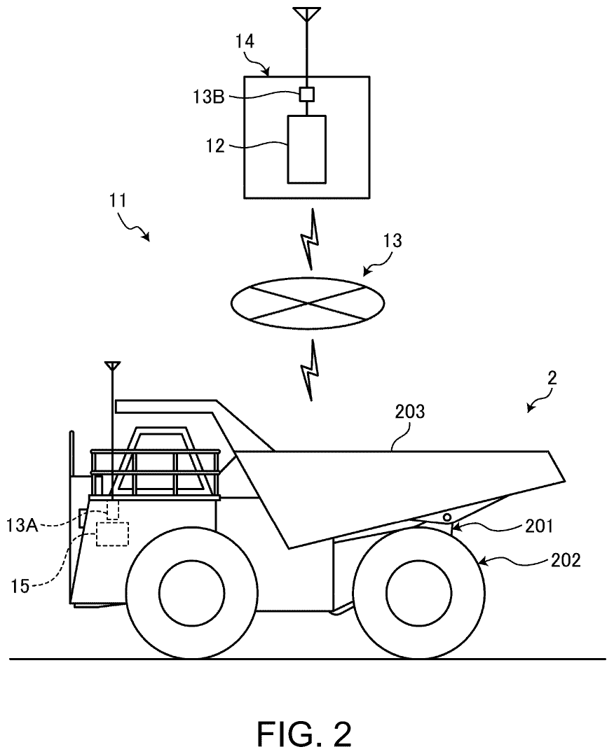

FIG. 2 is a schematic diagram illustrating a management system 11 for the unmanned dump truck 2 according to the embodiment. As shown in FIG. 2, the management system 11 includes a management device 12 and a communication system 13. The management device 12 is disposed outside the unmanned dump truck 2. The management device 12 is installed at a control facility 14 in the work site 1. The management device 12 includes a computer system. Examples of the communication system 13 include the internet, a mobile phone communication network, a satellite communication network, or a local area network (LAN).

The unmanned dump truck 2 includes a vehicle body 201, a traveling device 202, a dump body 203, a control device 15, and a wireless communication device 13A. The control device 15 includes a computer system. The wireless communication device 13A is connected to the control device 15.

The communication system 13 includes the wireless communication device 13A connected to the control device 15, and a wireless communication device 13B connected to the management device 12. The management device 12 and the control device 15 of the unmanned dump truck 2 wirelessly communicate with each other via the communication system 13.

The vehicle body 201 includes a vehicle body frame. The vehicle body 201 is supported by the traveling device 202. The traveling device 202 travels, supporting the vehicle body 201. The traveling device 202 includes a wheel, a tire mounted on the wheel, an engine, a brake device, and a steering device. The dump body 203 is a member on which a load is loaded. The dump body 203 is supported by the vehicle body 201. The dump body 203 performs a dumping operation and a lowering operation. The dumping operation refers to an operation of causing the dump body 203 to move away from the vehicle body 201 and incline in a dumping direction. The lowering operation refers to an operation of causing the dump body 203 to approach the vehicle body 201. In the case of performing the loading work, the dump body 203 performs the lowering operation. In the case of performing the discharging work, the dump body 203 performs the dumping operation.

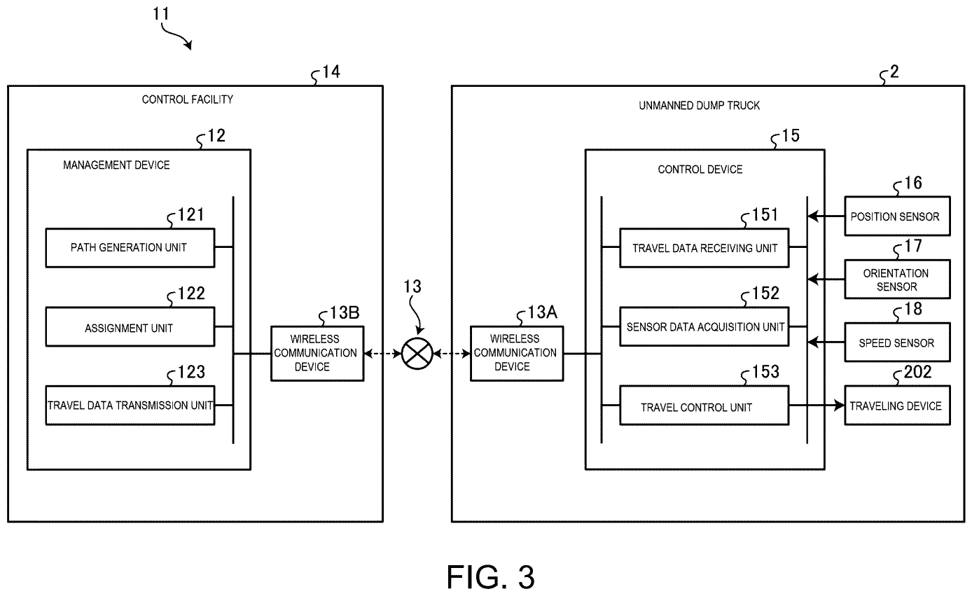

FIG. 3 is a block diagram illustrating the management system 11 for the unmanned dump truck 2 according to the embodiment. As illustrated in FIG. 3, the unmanned dump truck 2 includes the control device 15, the wireless communication device 13A, a position sensor 16, an orientation sensor 17, a speed sensor 18, and the traveling device 202. Each of the wireless communication device 13A, the position sensor 16, the orientation sensor 17, and the speed sensor 18 can communicate with the control device 15. The traveling device 202 is controlled by the control device 15.

The position sensor 16 detects the position of the unmanned dump truck 2. The position of the unmanned dump truck 2 is detected by using a global navigation satellite system (GNSS). The global navigation satellite system includes the global positioning system (GPS). The global navigation satellite system detects a position in a global coordinate system defined by coordinate data of latitude, longitude, and altitude. The global coordinate system refers to a coordinate system fixed to the earth. The position sensor 16 includes a GNSS receiver and detects an absolute position of the unmanned dump truck 2 indicating the position of the unmanned dump truck 2 in the global coordinate system.

The orientation sensor 17 detects the orientation of the unmanned dump truck 2. The orientation of the unmanned dump truck 2 includes the yaw angle of the unmanned dump truck 2. When an axis extending in the vertical direction at the center of gravity of the vehicle body 201 is defined as a yaw axis, the yaw angle refers to a rotation angle around the yaw axis. Examples of the orientation sensor 17 include a gyro sensor.

The speed sensor 18 detects the traveling speed of the unmanned dump truck 2. Examples of the speed sensor 18 include a pulse sensor that detects the rotation of the wheel of the unmanned dump truck 2.

The management device 12 includes a path generation unit 121, an assignment unit 122, and a travel data transmission unit 123.

The path generation unit 121 generates a path 30 indicating the target traveling route of the unmanned dump truck 2. The unmanned dump truck 2 travels in the work site 1 in accordance with the path 30. The path generation unit 121 generates the path 30 such that the unmanned dump truck 2 enters the discharging point 40. The assignment unit 122 assigns a discharging point 40 and a path 30 to each of the plurality of unmanned dump trucks 2. The assignment unit 122 determines the order of the unmanned dump trucks 2 entering the discharging point 40. The travel data transmission unit 123 transmits travel data indicating the traveling conditions of the unmanned dump truck 2 to the unmanned dump truck 2. The travel data of the unmanned dump truck 2 includes the path 30 generated by the path generation unit 121. The travel data transmission unit 123 transmits the travel data of the unmanned dump truck 2 to the control device 15 of the unmanned dump truck 2 via the communication system 13.

The control device 15 includes a travel data receiving unit 151, a sensor data acquisition unit 152, and a travel control unit 153. The travel data receiving unit 151 acquires the travel data of the unmanned dump truck 2 transmitted from the travel data transmission unit 123, from the management device 12 via the communication system 13. The sensor data acquisition unit 152 acquires detection data of the position sensor 16, detection data of the orientation sensor 17, and detection data of the speed sensor 18. The travel control unit 153 controls the traveling device 202, based on the traveling conditions of the unmanned dump truck 2 acquired by the travel data receiving unit 151 and the detection data acquired by the sensor data acquisition unit 152.

### [Computer System]

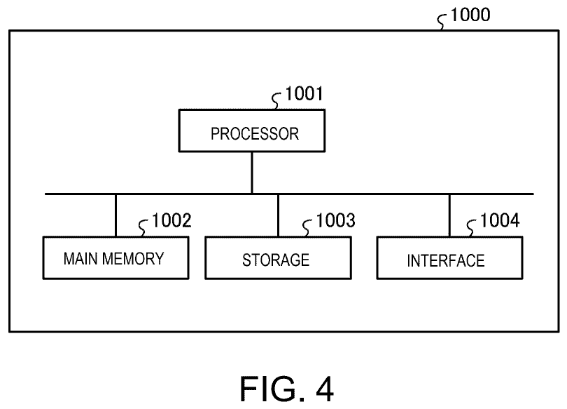

FIG. 4 is a diagram showing the hardware configuration of the management device 12 according to the embodiment. The management device 12 includes a computer system 1000. The computer system 1000 includes a processor 1001 such as a central processing unit (CPU), a main memory 1002 including a nonvolatile memory such as a read-only memory (ROM) and a volatile memory such as a random-access memory (RAM), a storage 1003, and an interface 1004 including an input/output circuit. The above functions of the management device 12 are stored as a computer program in the storage 1003. The processor 1001 reads out the computer program from the storage 1003, loads the computer program into the main memory 1002, and executes the above processing in accordance with the program. Note that the computer program may be distributed to the computer system 1000 via a network. Each of the control devices 15, too, includes the computer system 1000 as shown in FIG. 4. The above functions of the control device 15 are stored as a computer program in the storage 1003.

### [Traveling Conditions]

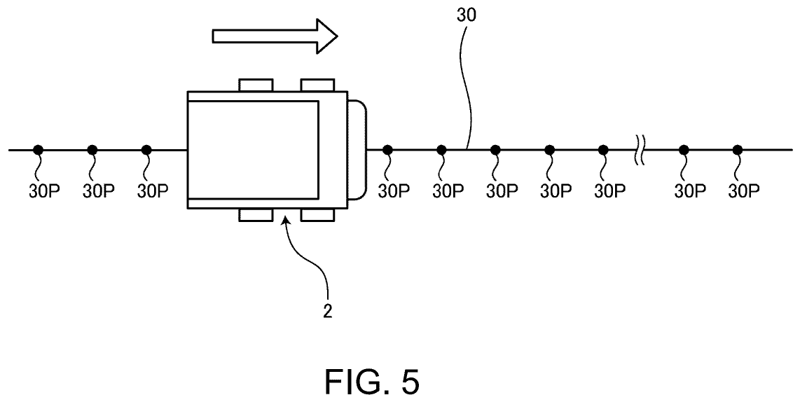

FIG. 5 is a schematic diagram illustrating the traveling conditions of the unmanned dump truck 2 according to the embodiment. The travel data indicating the traveling conditions of the unmanned dump truck 2 includes a traveling point 30P, the path 30, a target position of the unmanned dump truck 2, a target orientation of the unmanned dump truck 2, and a target traveling speed of the unmanned dump truck 2.

A plurality of traveling points 30P are set in the work site 1. The traveling point 30P defines the target position of the unmanned dump truck 2. The target orientation of the unmanned dump truck 2 and the target traveling speed of the unmanned dump truck 2 are set for each of the plurality of traveling points 30P. The plurality of traveling points 30P are set, spaced apart from each other. The interval between the traveling points 30P is 1 m or longer and 5 m or shorter. The interval between the traveling points 30P may be uniform or non-uniform. In the embodiment, the traveling points 30P are set at an interval of 1 m.

The path 30 refers to an imaginary line indicating the target traveling route of the unmanned dump truck 2. The path 30 is defined by a trajectory of passage through the plurality of traveling points 30P. The unmanned dump truck 2 travels in the work site 1 in accordance with the path 30. The unmanned dump truck 2 travels such that the center of the unmanned dump truck 2 and the path 30 coincide with each other in a vehicle width direction of the unmanned dump truck 2.

The target position of the unmanned dump truck 2 refers to the target position of the unmanned dump truck 2 when passing through the traveling point 30P. The target position of the unmanned dump truck 2 may be defined in a local coordinate system of the unmanned dump truck 2 or may be defined in a global coordinate system. The target orientation of the unmanned dump truck 2 refers to the target orientation of the unmanned dump truck 2 when passing through the traveling point 30P. The target traveling speed of the unmanned dump truck 2 refers to the target traveling speed of the unmanned dump truck 2 when passing through the traveling point 30P.

The travel control unit 153 controls the traveling device 202 such that the unmanned dump truck 2 travels along the path 30, based on the travel data of the unmanned dump truck 2 and the detection data acquired from the sensor data acquisition unit 152. The travel control unit 153 controls the traveling device 202 such that the deviation between the detected position of the unmanned dump truck 2 detected by the position sensor 16 when passing through the traveling point 30P and the target position of the unmanned dump truck 2 set for the traveling point 30P decreases. The travel control unit 153 controls the traveling device 202 such that the deviation between the detected orientation of the unmanned dump truck 2 detected by the orientation sensor 17 when passing through the traveling point 30P and the target orientation of the unmanned dump truck 2 set for the traveling point 30P decreases. The travel control unit 153 controls the traveling device 202 such that the deviation between the detected traveling speed of the unmanned dump truck 2 detected by the speed sensor 18 when passing through the traveling point 30P and the target traveling speed of the unmanned dump truck 2 set for the traveling point 30P decreases.

### [Discharging Area]

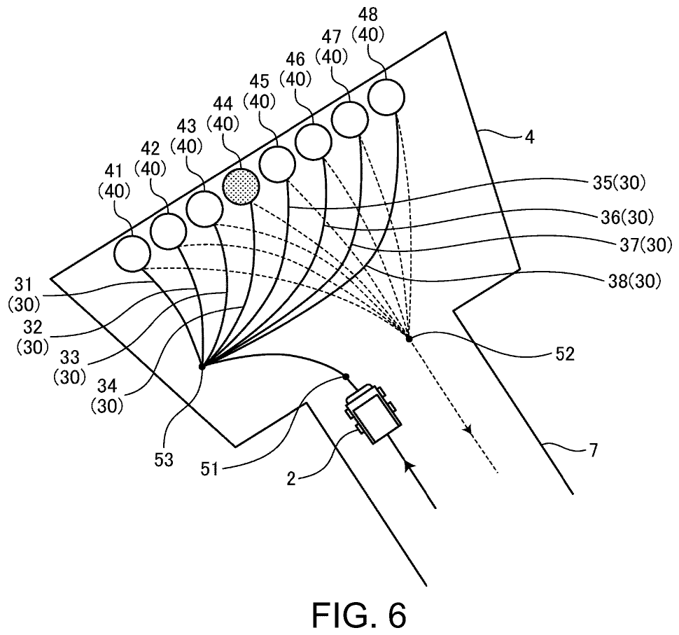

FIG. 6 is a schematic diagram illustrating the discharging area 4 according to the embodiment. An entry point 51 and an exit point 52 are set at the boundary between the discharging area 4 and the traveling track 7. The entry point 51 refers to a position through which the unmanned dump truck 2 entering the discharging area 4 from the traveling track 7 passes. The unmanned dump truck 2 in a loaded state passes through the entry point 51 and enters the discharging area 4 from the traveling track 7. The loaded state refers to a state where a load is loaded on the dump body 203. The exit point 52 refers to a position through which the unmanned dump truck 2 exiting the discharging area 4 to the traveling track 7 passes. The unmanned dump truck 2 in an unloaded state passes through the exit point 52 and exits the discharging area 4 to the traveling track 7. The unloaded state refers to a state where no load is loaded on the dump body 203. One entry point 51 is set. One exit point 52 is set.

The plurality of discharging points 40 are set in the discharging area 4. The discharging point 40 refers to a position where the unmanned dump truck 2 discharges the load loaded on the dump body 203. The plurality of discharging points 40 are set in the discharging area 4. In the embodiment, eight discharging points 40 are set in the discharging area 4. The discharging points 40 include a first discharging point 41, a second discharging point 42, a third discharging point 43, a fourth discharging point 44, a fifth discharging point 45, a sixth discharging point 46, a seventh discharging point 47, and an eighth discharging point 48.

A switchback point 53 is set in the discharging area 4. The switchback point 53 refers to a position where the unmanned dump truck 2 makes a switchback turn. The switchback refers to an operation in which the unmanned dump truck 2 moving forward changes the movement direction at an acute angle and approaches the discharging point 40 while moving backward. In the embodiment, one switchback point 53 each is set for each of the plurality of discharging points 40. The plurality of discharging points 40 may be set at mutually overlapping positions (the same position) or may be set at different positions from each other. FIG. 6 shows an example in which eight switchback points 53 are set at the same position.

The unmanned dump truck 2, upon entering the discharging area 4 from the traveling track 7 while moving forward, makes a switchback turn at the switchback point 53 and subsequently enters the discharging point 40 while moving backward. After the unmanned dump truck 2 enters the discharging point 40, the dump body 203 performs the dumping operation and the loaded is thus discharged at the discharging point 40. Upon discharging the load, the unmanned dump truck 2 exits the discharging area 4 to the traveling track 7 while moving forward.

The path generation unit 121 generates the path 30 such that the path 30 passes through each of the entry point 51, the switchback point 53, the discharging point 40, and the exit point 52. The path 30 is generated such that the unmanned dump truck 2 enters the discharging point 40. In the discharging area 4, one pass 30 each is generated for each of the plurality of discharging points 40. In the embodiment, eight paths 30 are generated in the discharging area 4. The paths 30 include a first path 31, a second path 32, a third path 33, a fourth path 34, a fifth path 35, a sixth path 36, a seventh path 37, and an eighth path 38. The first path 31 leads to the first discharging point 41. The first path 31 is generated such that the unmanned dump truck 2 enters the first discharging point 41. The second path 32 leads to the second discharging point 42. The second path 32 is generated such that the unmanned dump truck 2 enters the second discharging point 42. The third path 33 leads to the third discharging point 43. The third path 33 is generated such that the unmanned dump truck 2 enters the third discharging point 43. The fourth path 34 leads to the fourth discharging point 44. The fourth path 34 is generated such that the unmanned dump truck 2 enters the fourth discharging point 44. The fifth path 35 leads to the fifth discharging point 45. The fifth path 35 is generated such that the unmanned dump truck 2 enters the fifth discharging point 45. The sixth path 36 leads to the sixth discharging point 46. The sixth path 46 is generated such that the unmanned dump truck 2 enters the sixth discharging point 46. The seventh path 37 leads to the seventh discharging point 47. The seventh path 27 is generated such that the unmanned dump truck 2 enters the seventh discharging point 47. The eighth path 38 leads to the eighth discharging point 48. The eighth path 48 is generated such that the unmanned dump truck 2 enters the eighth discharging point 48.

The discharging point 40 indicates the target position of the discharging work by the unmanned dump truck 2. In the description below, the discharging point 40 after the unmanned dump truck 2 performs the discharge is referred to as a discharge-finished point as appropriate, and the discharging point 40 before the unmanned dump truck 2 performs the discharge is referred to as an unused discharging point as appropriate. In the example shown in FIG. 6, the fourth discharging point 44 is a discharge-finished point, and the first, second, third, fifth, sixth, seventh, and eighth discharging points 41, 42, 43, 45, 46, 47, and 48 are unused discharging points. The unmanned dump truck 2 performs the discharge at an unused discharging point and does not perform the discharge at a discharge-finished point. The plurality of unmanned dump trucks 2 sequentially enter different unused discharging points from each other.

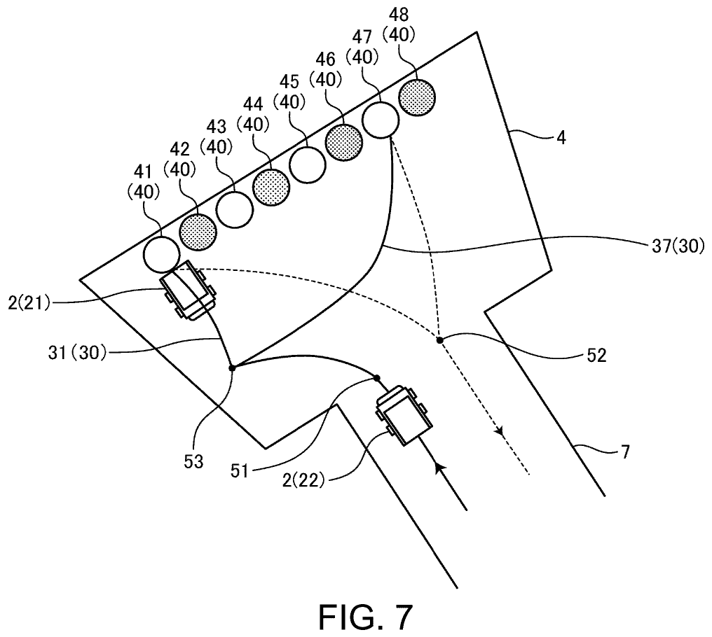

FIG. 7 is a diagram illustrating the operation of the unmanned dump truck 2 in the discharging area 4 according to the embodiment. A plurality of unmanned dump trucks 2 sequentially enter the discharging area 4 where the discharging points 40 are set, from the traveling track 7. In the description below, the unmanned dump truck 2 arriving at the discharging area 4 first is referred to as a preceding vehicle 21 as appropriate, and the unmanned dump truck 2 arriving at the discharging area 4 next to the preceding vehicle 21 is referred to as a subsequent vehicle 22 as appropriate.

The assignment unit 122 assigns an unused discharging point and a path 30 to each of the plurality of unmanned dump trucks 2. In the example illustrated in FIG. 7, the assignment unit 122 assigns the first discharging point 41 and the first path 31 leading to the first discharging point 41, to the preceding vehicle 21. The preceding vehicle 21 enters the first discharging point 41, which is an unused discharging point, according to the first path 31. In the state where the preceding vehicle 21 is present in the discharging area 40, the subsequent vehicle 22 enters the discharging area 4 from the traveling track 7.

In the embodiment, the assignment unit 122 assigns, to the subsequent vehicle 22, an unused discharging point different from the first discharging point 41 and a path 30 different from the first path 31 to enter that unused discharging point, based on the first discharging point 41 and the first path 31 to enter the first discharging point 41 assigned to the preceding vehicle 21. The assignment unit 122 assigns, to the subsequent vehicle 22, an unused discharging point and a path 30 that can minimize the stop time of the preceding vehicle 21 and the subsequent vehicle 22, from among the plurality of unused discharging points and the plurality of paths 30. The assignment unit 122 may assign, to the subsequent vehicle 22, for example, an unused discharging point and a path 30 that can minimize the sum of the stop time of the preceding vehicle 21 and the stop time of the subsequent vehicle 22.

In the case where the preceding vehicle 21 and the subsequent vehicle 22 are present in the discharging area 4, the preceding vehicle 21 or the subsequent vehicle 22 needs to be stopped in order to avoid interference between the preceding vehicle 21 and the subsequent vehicle 22, depending on the unused discharging point assigned to the subsequent vehicle 22. If the stop time of the unmanned dump truck 2 is long, productivity at the work site 1 may decrease.

The assignment unit 122 assigns, to the subsequent vehicle 22, an unused discharging point and a path 30 that can minimize the stop time of the preceding vehicle 21 and the subsequent vehicle 22, based on the first discharging point 41 and the first path 31 leading to the first discharging point 41 assigned to the preceding vehicle 21. The assignment unit 122 can assign, for example, one unused discharging point of the third, fifth, and seventh discharging points 43, 45, and 47 to the subsequent vehicle 22 so as to minimize the stop time of the subsequent vehicle 22, based on a predetermined calculation method. FIG. 7 shows an example in which the seventh discharging point 47, of the third, fifth, and seventh discharging points 43, 45, and 47, which are the unused discharging points which the subsequent vehicle 22 can enter, and the seventh path 37, are assigned to the subsequent vehicle 22. Also, FIG. 7 is an example. The discharging point 40 and the path 30 assigned to the unmanned dump truck 2 to minimize the stop time of the unmanned dump truck 2 are changed, based on the number and positions of unused discharging areas, the position of the switchback point 53, the number of unmanned dump trucks 2 present in the discharging area 4, and the time interval of the unmanned dump trucks 2 entering the discharging area 4 from the traveling track 7, or the like.

### [Assignment of Discharging Point and Path]

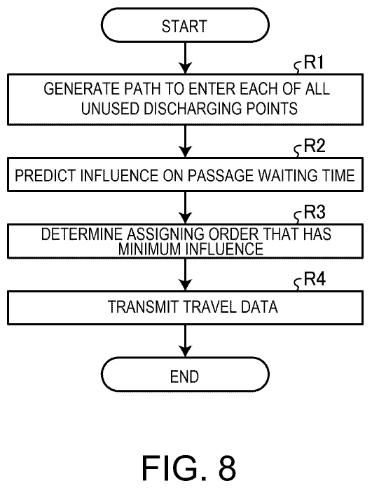

Hereinafter, a method for assigning the discharging point 40 and the path 30 will be described. FIG. 8 is a flowchart illustrating an example of a method for assigning the discharging point 40 and the path 30 according to the embodiment. The path generation unit 121 generates a path to enter each of all the unused discharging points (step R1). When there are eight unused discharging points, the path generation unit 121 generates the first to eighth paths 31 to 38. When the unused discharging points are, for example, the third, fifth, and seventh discharging points 43, 45, and 47, the path generation unit 121 generates the third, fifth, and seventh paths 33, 35, and 37.

The assignment unit 122 predicts the influence of the existence of the unmanned dump truck 2 in the discharging area 4 on the stop time of another unmanned dump truck 2 (step R2). In the embodiment, the assignment unit 122 evaluates the stop time during which another unmanned dump truck 2 is stopped in order to suppress interference with one unmanned dump truck 2, based on an estimated interference time C_{i, j}. In the description below, the stop time during which another unmanned dump truck 2 is stopped to avoid interference with one unmanned dump truck 2 is referred to as a passage waiting time as appropriate.

The assignment unit 122 calculates the estimated interference time, based on the discharging point 40 and the path 30, and assigns an unused discharging point and a path to each of the plurality of unmanned dump trucks 2, based on the estimated interference time. The assignment unit 122 calculates the estimated interference time, based on the stay time of the unmanned dump truck 2 in each of the plurality of paths 30.

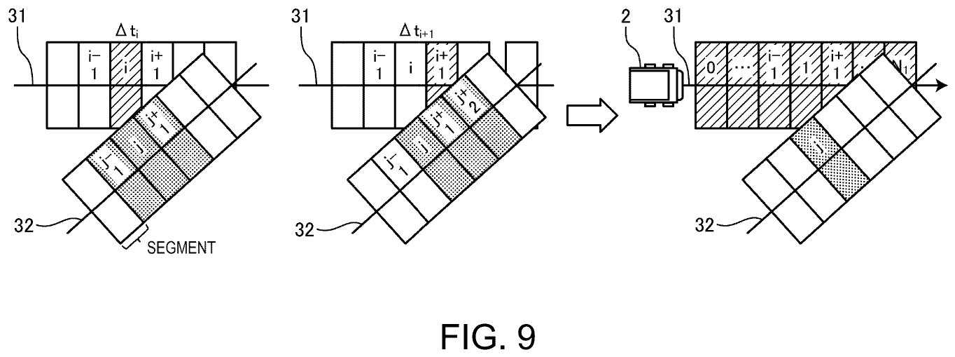

FIG. 9 is a diagram illustrating the estimated interference time according to the embodiment. The estimated interference time refers to a time during which, in the case of another unmanned dump truck 2 passing to cross the path 30 of one unmanned dump truck 2, a segment of the path 30 of another unmanned dump truck 2 interferes with the path 30. As illustrated in FIG. 9, each of the first path 31 and the second path 32 is divided into a plurality of segments. On the way from the entry point 51 to the exit point 52, the first path 31 is divided into N₁ segments. On the way from the entry point 51 to the exit point 52, the second path 32 is divided into N₂ segments. When the first path 31 and the second path 32 intersect, the unmanned dump truck 2 traveling along the first path 31 and the unmanned dump truck 2 traveling along the second path 32 may interfere with each other. In FIG. 9, Δtᵢ is a stay time during which the unmanned dump truck 2 stays in the i-th segment of the first path 31. The time Tj during which the first path 31 interferes with the j-th segment of the second path 32 is expressed by the following equation (1).

$$\begin{matrix}[ Math . 1 ] & \\ {T}_{j} = {\sum }_{i = 0}^{{N}_{1}} Δ {t}_{i} {x}_{i} & ( 1 )\end{matrix}$$

[xᵢ=1 when interference occurs, and xᵢ=0 when interference does not occur]

The estimated interference time C_{1, 2} of the first path 31 with the second path 32 is expressed by the following equation (2).

$$\begin{matrix}[ Math . 2 ] & \\ {C}_{1 , 2} = \frac{1}{{N}_{2}} {\sum }_{j = 0}^{{N}_{2}} {T}_{j} & ( 2 )\end{matrix}$$

That the estimated interference time C_{1, 2} is long means that the passage waiting time during which the unmanned dump truck 2 traveling along the second path 32 is stopped in order to avoid interference with the unmanned dump truck 2 traveling along the first path 31 is long.

The state where a segment of the first path 31 and a segment of the second path 32 interfere with each other may include not only the state where a segment of the first path 31 and a segment of the second path 32 at least partially overlap each other but also the state where a segment of the first path 31 and a segment of the second path 32 approach each other at a predetermined distance or shorter. For example, in the state shown at the leftmost in FIG. 9, an [i] segment of the first path 31 partially overlap a [j] segment and a [j+1] segment of the second path 32, and the [i] segment of the first path 31 and a [j−1] segment of the second path 32 do not overlap each other. The state where a segment of the first path 31 interferes with a segment of the second path 32 may include not only the relationship between the [i] segment, and the [j] segment and the [j+1] segment, but also the relationship between the [i] segment and the [j−1] segment.

The method for calculating the estimated interference time C_{1, 2} caused by the first path 31 to the second path 32 is described above with reference to FIG. 9. When there are eight paths 30 to cause the unmanned dump truck 2 to enter the unused discharging point, the assignment unit 122 calculates each estimated interference time that the first path 31 causes to each of the second to eighth paths 32 to 38. The assignment unit 122 also calculates the estimated interference time that the second path 32 causes to each of the first path 31 and the third to eighth paths 33 to 38. The assignment unit 122 calculates the estimated interference time C_{i, j} for all combinations of the eight paths 30.

Based on the estimated interference time C_{i, j}, the assignment unit 122 determines the assigning order of the unmanned dump truck 2 to the unused discharging point that has minimum influence on the passage waiting time (step R3). After the assigning order of the unmanned dump truck 2 to the unused discharging point is determined, the travel data transmission unit 123 transmits the travel data including the path 30 to enter the unused discharging point to the unmanned dump truck 2, based on the assigning order (step R4).

As the sum of the estimated interference times C_{i, j} for all combinations of the eight paths 30 is minimized, the sum of the passage waiting times of the unmanned dump trucks 2 traveling along the eight paths 30, respectively, can be minimized. The assignment unit 122 calculates a combination that minimizes the sum of the estimated interference times C_{i, j} for all combinations of the eight paths 30, based on a dynamic programming method. The assignment unit 122 determines the assigning order of the unmanned dump truck 2 to the unused discharging point, based on the dynamic programming method, so as to minimize the sum of the estimated interference times C_{i, j} for all the combinations of the eight paths 30. The assignment unit 122 performs the calculation expressed by the formula (3).

$$\begin{matrix}[ Math . 3 ] & \\ min ( {\sum }_{i = 0}^{n} {\sum }_{j = 0}^{n} {C}_{i , j} {x}_{i , j} ) & ( 3 )\end{matrix}$$

[xᵢⱼ=1 when selected, or xᵢⱼ=0 when not selected]

As an example, the assignment unit 122 assigns the first discharging point 41 and the first path 31 to the unmanned dump truck 2 entering the discharging area 4 first, assigns the fifth discharging point 45 and the fifth path 35 to the unmanned dump truck 2 entering the discharging area 4 next, assigns the second discharging point 42 and the second path 32 to the unmanned dump truck 2 entering the discharging area 4 next, and assigns the sixth discharging point 46 and the sixth path 36 to the unmanned dump truck 2 entering the discharging area 4 next. Based on the above calculation method, an unused discharging point and a path 30 are assigned to each of the plurality of unmanned dump trucks 2, and the sum of the passage waiting times indicating the times for which the eight unmanned dump trucks 2 are stopped in the discharging area 4 is thus minimized. Thus, a decrease in productivity at the work site 1 is suppressed.

### [Assignment in Consideration of Arrival Time of Subsequent Vehicle]

A plurality of unmanned dump trucks 2 sequentially enter the discharging area 4. Next, an example in which an unused discharging point and a path 30 are assigned, based on an arrival time at which the subsequent vehicle 22 is expected to arrive at the discharging area 4, will be described.

The assignment unit 122 can predict the arrival time of the subsequent vehicle 22 at the discharging area 4, for example, based on the distance from the current position of the subsequent vehicle 22 to the discharging area 4 and the target traveling speed of the subsequent vehicle 22 defined by the travel data of the subsequent vehicle 22. The assignment unit 122 can acquire the current position of the subsequent vehicle 22, based on the detection data of the position sensor 16 installed in the subsequent vehicle 22.

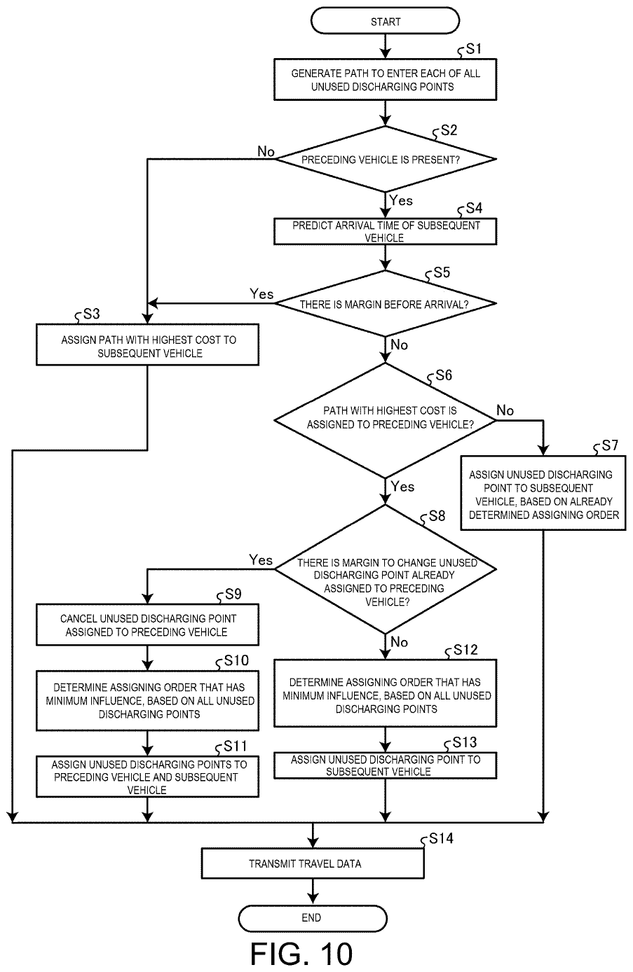

FIG. 10 is a flowchart illustrating an example of a method for assigning the discharging point 40 and the path 30 in consideration of the arrival time of the subsequent vehicle 22 at the discharging area 4 according to the embodiment. The path generation unit 121 generates a path to enter each of all the unused discharging points (step S1). The assignment unit 122 determines the assigning order that has minimum influence on the passage waiting time in accordance with the procedures of steps R1 to R3 described with reference to FIG. 8.

The assignment unit 122 determines whether the preceding vehicle 21 is present (step S2). In step S2, when it is determined that there is no preceding vehicle 21 (No in step S2), the assignment unit 122 assigns the path 30 with the highest cost to the subsequent vehicle 22 (step S3). The travel data transmission unit 123 transmits the travel data including the path 30 with the highest cost to the subsequent vehicle 22 (step S14).

The path 30 with the highest cost refers to a path 30 that increases the sum of the passage waiting times. For example, the path 30 passing through a central part of the discharging area 4 is likely to have a long estimated interference time with another path 30 and thus become a factor that increases the sum of the passage waiting times. The assignment unit 122 assigns, to the subsequent vehicle 22, the path 30 having the longest estimated interference time, of the plurality of paths 30 to cause the unmanned dump truck 2 to enter the unused discharging point. The assignment unit 122 performs the calculation expressed by the formula (4) and thus assigns the path 30 with the highest cost to the subsequent vehicle 22.

$$\begin{matrix}[ Math . 4 ] & \\ min ( {\sum }_{i = 0}^{n} {\sum }_{j = 0}^{n} {C}_{i , j} {x}_{i , j} ) ( i , j ) ∈ V / s & ( 4 )\end{matrix}$$

In the formula (4), V means all of the paths 30 to cause the unmanned dump truck 2 to enter the unused discharging point, and s indicates the path 30 eliminated from all the paths 30. If the sum of the estimated interference times is the smallest when one path 30 is eliminated, it means that the cost of the eliminated path 30 is the highest.

When there is no preceding vehicle 21, the subsequent vehicle 22 is made to pass through the path 30 with a high cost to perform the discharge, and thus an increase in the passage waiting time is suppressed even if a plurality of unmanned dump trucks 2 subsequently enter the discharging area 4.

When it is determined in step S2 that the preceding vehicle 21 is present (Yes in step S2), the assignment unit 122 predicts the arrival time of the subsequent vehicle 22 at the discharging area 4 (step S4). Also, the assignment unit 122 predicts the time during which the preceding vehicle 21 stays in the discharging area 4. The assignment unit 122 determines whether there is a margin before the arrival of the subsequent vehicle 22 (step S5). That there is a margin before the arrival of the subsequent vehicle 22 means that the subsequent vehicle 22 arrives at the discharging area 4 after the preceding vehicle 21 exits the discharging area 4. That there is no margin before the arrival of the subsequent vehicle 22 means that the subsequent vehicle 22 arrives at the discharging area 4 while the preceding vehicle 21 stays in the discharging area 4.

When it is determined in step S5 that there is a margin before the arrival of the subsequent vehicle 22 (Yes in step S5), the assignment unit 122 performs the processing of step S3. When it is determined in step S5 that there is no margin before the arrival of the subsequent vehicle 22 (No in step S5), the assignment unit 122 determines whether the path with the highest cost is assigned to the preceding vehicle 21 (step S6). When it is determined in step S6 that the path with the highest cost is not assigned to the preceding vehicle 21 (No in step S6), the assignment unit 122 assigns an unused discharging point to the subsequent vehicle 22, based on the assigning order to the unused discharging points already determined in accordance with the procedures of steps R1 to R3 described with reference to FIG. 8 (step S7). In step S7, the assignment unit 122 assigns, to the subsequent vehicle 22, an unused discharging point next to the unused discharging point assigned to the preceding vehicle 21 in the assigning order to the unused discharging points already determined in accordance with the procedures of steps R1 to R3 described with reference to FIG. 8.

When it is determined in step S6 that the path with the highest cost is assigned to the preceding vehicle 21 (Yes in step S6), the assignment unit 122 determines whether there is a margin of time to change the unused discharging point and the path 30 assigned to the preceding vehicle 21 (step S8).

When it is determined in step S8 that there is a margin for change (Yes in step S8), the unused discharging point and the path 30 assigned to the preceding vehicle are canceled (step S9). After the unused discharging point and the path 30 assigned to the preceding vehicle are canceled, the assignment unit 122 determines the assigning order to the unused discharging point that has minimum influence on the passage waiting time, according to the procedures of steps R1 to R3 described with reference to FIG. 8, based on all the unused discharging points (step S10). The assignment unit 122 assigns an unused discharging point and a path 30 to the preceding vehicle 21 and the subsequent vehicle 22, based on the assigning order determined in step S10 (step S11).

When the subsequent vehicle 22 is about to enter the discharging area 4, if the path 30 with a high cost is still assigned to the preceding vehicle 21, the subsequent vehicle 22 is more likely to stop in order to suppress interference with the preceding vehicle 21. When the subsequent vehicle 22 is about to enter the discharging area 4, if there is a margin of time to be able to change the path 30 with a high cost assigned to the preceding vehicle 21, the unused discharging point and the path 30 assigned to the preceding vehicle 21 are changed and an increase in the sum of the passage waiting times is thus suppressed.

When it is determined in step S8 that there is no margin for change (No in step S8), the assigning order to the unused discharging point that has minimum influence on the passage waiting time is determined according to the procedures of steps R1 to R3 described with reference to FIG. 8, based on all the unused discharging points (step S12). Note that all the unused discharging points include the unused discharging point already assigned to the preceding vehicle 21. When an unused discharging point close to the unused discharging point already assigned to the preceding vehicle 21 is assigned to the subsequent vehicle 22, the subsequent vehicle 22 is more likely to interfere with the preceding vehicle 21. The assignment unit 122 determines the assigning order in consideration of the unused discharging point already assigned to the preceding vehicle 21 and thus can determine the assigning order to the unused discharging point that has minimum influence on the passage waiting time. The assignment unit 122 assigns an unused discharging point and a path 30 to the subsequent vehicle 22, based on the assigning order determined in step S12 (step S13).

### Effects

As described above, in the embodiment, the management system 11 for the unmanned dump truck 2 includes the path generation unit 121, which generates the path 30 indicating the target traveling route of the unmanned dump truck 2 such that the unmanned dump truck 2 enters the discharging point 40, and the assignment unit 122, which assigns the second discharging point 40 and the second path 30 to enter the second discharging point 40, to the second unmanned dump truck 2, based on the first discharging point 40 and the first path 30 to enter the first discharging point 40 assigned to the first unmanned dump truck 2. Since the discharging point 40 and the path 30 of the second unmanned dump truck 2 are assigned in consideration of the first unmanned dump truck 2 traveling along the first path 30, the interference between the first unmanned dump truck 2 and the second unmanned dump truck 2 is avoided and the passage waiting time of at least one of the first unmanned dump truck 2 and the second unmanned dump truck 2 is suppressed from becoming longer. Therefore, a decrease in productivity at the work site is suppressed.

### OTHER EMBODIMENTS

In the above embodiment, at least a part of the functions of the control device 15 may be provided in the management device 12, or at least a part of the functions of the management device 12 may be provided in the control device 15.

In the above embodiment, a plurality of functions of the management device 12 may be configured with separate pieces of hardware. That is, the path generation unit 121, the assignment unit 122, and the travel data transmission unit 123 may be configured with separate pieces of hardware, respectively. Similarly, a plurality of functions of the control device 15 may be configured with separate pieces of hardware.

In the above embodiment, the unmanned vehicle 2 is assumed to be an unmanned dump truck. The unmanned vehicle 2 may be a vehicle other than a dump truck.

### REFERENCE SIGNS LIST

1 . . . work site, 2 . . . unmanned dump truck (unmanned vehicle), 3 . . . loading area, 4 . . . discharging area
5 . . . parking area, 6 . . . fueling area
7 . . . traveling track, 9 . . . loader
11 . . . management system, 12 . . . management device
13 . . . communication system, 13A . . . wireless communication device, 13B . . . wireless communication device,
14 . . . control facility, 15 . . . control device,
16 . . . position sensor, 17 . . . orientation sensor,
18 . . . speed sensor, 30 . . . path, 30P . . . traveling point,
21 . . . preceding vehicle, 22 . . . subsequent vehicle,
31 . . . first path, 32 . . . second path, 33 . . . third path,
34 . . . fourth path, 35 . . . fifth path, 36 . . . sixth path,
37 . . . seventh path, 38 . . . eighth path, 40 . . . discharging point, 41 . . . first discharging point, 42 . . . second discharging point, 43 . . . third discharging point, 44 . . . fourth discharging point, 45 . . . fifth discharging point, 46 . . . sixth discharging point, 47 . . . seventh discharging point, 48 . . . eighth discharging point, 51 . . . entry point, 52 . . . exit point,
53 . . . switchback point, 121 . . . path generation unit,
122 . . . assignment unit, 123 . . . travel data transmission unit,
151 . . . travel data receiving unit, 152 . . . sensor data acquisition unit, 153 . . . travel control unit, 201 . . . vehicle body, 202 . . . traveling device, 203 . . . dump body, 1000 . . . computer system, 1001 . . . processor, 1002 . . . main memory,
1003 . . . storage, 1004 . . . interface.

1. A management system of an unmanned dump truck, comprising a processor configured to function as:
a path generation unit generating a path indicating a target traveling route of an unmanned dump truck such that the unmanned dump truck enters a discharging point; and
an assignment unit assigning a second discharging point and a second path to enter the second discharging point to a second unmanned dump truck, based on a first discharging point and a first path to enter the first discharging point assigned to a first unmanned dump truck.

2. The management system of an unmanned dump truck according to claim 1, wherein
the discharging point includes a discharge-finished point after discharge is performed, and an unused discharging point before discharge is performed,
a plurality of unmanned dump trucks sequentially enters different unused discharging points from each other,
the path is generated one each for each of a plurality of unused discharging points, and
the assignment unit assigns an unused discharging point and a path to each of the plurality of unmanned dump trucks.

3. The management system of an unmanned dump truck according to claim 2, wherein
the assignment unit calculates an estimated interference time, based on a discharging point and a path, and assigns the unused discharging point and the path, based on the estimated interference time.

4. The management system of an unmanned dump truck according to claim 3, wherein
the assignment unit calculates the estimated interference time, based on a stay time of the unmanned dump truck in each of a plurality of paths.

5. The management system of an unmanned dump truck according to claim 2, wherein
when a plurality of unmanned dump trucks sequentially enters a discharging area where the discharging point is set, an unmanned dump truck arriving at the discharging area first is defined as a preceding vehicle, and an unmanned dump truck arriving at the discharging area next to the preceding vehicle is defined as a subsequent vehicle,
the assignment unit assigns the unused discharging point and the path, based on an arrival time at which the subsequent vehicle is expected to arrive at the discharging area.

6. A management method of an unmanned dump truck, comprising:
generating a path indicating a target traveling route of an unmanned dump truck such that the unmanned dump truck enters a discharging point; and
assigning a second discharging point and a second path to enter the second discharging point to a second unmanned dump truck, based on a first discharging point and a first path to enter the first discharging point assigned to a first unmanned dump truck.

7. The management method of an unmanned dump truck according to claim 6, wherein
the discharging point includes a discharge-finished point after discharge is performed, and an unused discharging point before discharge is performed,
a plurality of unmanned dump trucks sequentially enters different unused discharging points from each other,
the path is generated one each for each of a plurality of unused discharging points, and
an unused discharging point and a path are assigned to each of the plurality of unmanned dump trucks.

8. The management method of an unmanned dump truck according to claim 7, comprising:
calculating an estimated interference time, based on a discharging point and a path, wherein
the unused discharging point and the path are assigned, based on the estimated interference time.

9. The management method of an unmanned dump truck according to claim 8, wherein
the estimated interference time is calculated, based on a stay time of the unmanned dump truck in each of the plurality of paths.

10. The management method of an unmanned dump truck according to claim 7, wherein
when a plurality of unmanned dump trucks sequentially enters a discharging area where the discharging point is set, an unmanned dump truck arriving at the discharging area first is defined as a preceding vehicle, and an unmanned dump truck arriving at the discharging area next to the preceding vehicle is defined as a subsequent vehicle,
the unused discharging point and the path are assigned, based on an arrival time at which the subsequent vehicle is expected to arrive at the discharging area.
